(19) United States
(12) Patent Application Publication
(10) Pub. No.: US 2026/0336923 A1
(43) Pub. Date: Oct. 29, 2026

(54) WASTE CONTAINER AND CONTROL CIRCUIT THEREOF

(71) Applicant: Chang'e Li, Dongguan (CN)

(72) Inventor: Chang'e Li, Dongguan (CN)

(21) Appl. No.: 19/731,066

(22) Filed: Jul. 5, 2026

(51) Int. Cl. B65F 1/16; B65F 1/06

(52) U.S. Cl. CPC B65F 1/1638; B65F 1/065; B65F 2210/138; B65F 2210/139; B65F 2210/168; B65F 2210/179; B65F 2210/188

(57) ABSTRACT

A waste container includes a container body, a lid drive mechanism connected to the container body, a lid, a main control board disposed in the lid, and a sensor assembly disposed directly in front of a top end of the container body. The lid has a frameless full-cover plate structure and a pivot connected to one side of a top opening of the container body, and the sensor assembly is electrically connected to the main control board and the lid drive mechanism. The main control board is triggered by a sensing signal from the sensor assembly to control the lid drive mechanism to drive the lid. The waste container realizes a structural design of a frameless full-cover lid, wherein the sensor assembly is separated from the lid, thereby avoiding the problem of the lid structure interfering with the sensing effect, reducing false triggering, and improving the accuracy of sensing.

### TECHNICAL FIELD

The present disclosure relates to the technical field of waste container, and more particularly to a waste container and a control circuit thereof.

### BACKGROUND

In the technical field of intelligent trash cans, sensor-activated lid-opening trash cans have gradually replaced traditional manually-operated lid trash cans and become mainstream choices for home and office scenarios, owing to their advantages of contactless opening and closing as well as their convenience. However, existing products exhibit significant deficiencies in the adaptability between structure and sensor-activated lid-opening function.

In conventional sensor-activated trash cans, sensing components are mostly disposed on the lid. To accommodate such a layout, the lid is designed with a raised border frame to avoid interference with a sensing port, making it difficult for the lid to completely cover the top opening of the can body when closed, and preventing the realization of a flat full-cover plate structure, which severely compromises the overall aesthetic appeal of the product. This integrated design of the lid and the sensing components tends to cause obstruction and interference to sensing signals during lid opening and closing operations, resulting in low sensing accuracy and frequent false triggering.

Furthermore, control circuits of most current intelligent trash cans suffer from deficiencies in multiple aspects. For example, their standby power consumption is relatively high, often reaching the milliampere level in a static state, leading to short battery life and requiring frequent charging or battery replacement. Additionally, functionality is relatively limited, providing only basic lid opening management without vacuum-assisted bag deployment, multi-level status indication, or low voltage management designs, making it difficult to satisfy user demands for intelligent and integrated usage.

### SUMMARY

The present disclosure provides a waste container and a control circuit thereof, aiming to solve at least one of the technical problems existing in the prior art.

The technical solution of the present disclosure is a waste container, which comprises: a container body; a lid having a frameless full-cover plate structure and a pivot connected to one side of a top opening of the container body; a lid drive mechanism connected to the container body; a main control board disposed in the lid; and a sensor assembly disposed directly in front of a top end of the container body, wherein the sensor assembly is electrically connected to the main control board and the lid drive mechanism, and wherein the main control board is triggered by a sensing signal from the sensor assembly to control the lid drive mechanism to drive the lid to flip and open.

According to some embodiments of the present disclosure, wherein the sensor assembly is mounted in a sensor mounting area provided on a front outer wall of a top end of the container body, the sensor assembly comprises a sensor head disposed in the sensor mounting area at an upward inclination angle of 45 degrees, and the sensor head has an oblique sensing direction outward from a front side of the container body.

According to some embodiments of the present disclosure, further comprising: a vacuum-assisted bag deployment device comprising a vacuum pump and a plurality of air suction holes, wherein the vacuum pump is disposed inside the container body, and the air suction holes are evenly distributed on an inner side wall of the container body.

According to some embodiments of the present disclosure, wherein a first touch button and a second touch button are provided in the sensor mounting area, both the first touch button and the second touch button are electrically connected to the main control board, the first touch button is configured to control a working state of the vacuum pump, and the second touch button is configured to control a power on/off state of the waste container and control an open/closed state of the lid.

According to some embodiments of the present disclosure, wherein: the main control board controls the waste container to be in a power-on state in response to the second touch button operating in a first activation mode; the main control board controls the waste container to be in a power-off state in response to the second touch button operating in a second activation mode; the main control board controls the lid to flip and open and remain in an open state in response to the second touch button operating in a third activation mode; and the main control board controls the lid to be in a closed state in response to the touch button operating in a fourth activation mode.

According to some embodiments of the present disclosure, further comprising: an indicator light disposed on an outer side of the sensor mounting area, wherein the indicator light is electrically connected to the main control board, and is configured to indicate a power on/off state of the waste container.

According to some embodiments of the present disclosure, the lid drive mechanism comprises a hinge assembly disposed on one side of a top end of the container body, the lid is rotatably connected to the container body through the hinge assembly, a torsion spring is disposed in the hinge assembly, two ends of the torsion spring respectively abutting against the container body and the lid, a drive member is disposed in the container body and is electrically connected to the main control board, and an output end of the drive member is drivingly connected to the lid to drive the lid to flip.

According to some embodiments of the present disclosure, wherein the drive member is a micro motor, and an output shaft of the micro motor is drivingly connected to the hinge assembly through a gear set, and a rotation angle of the micro motor is controlled by the main control board to enable an opening angle of the lid to be 90 degrees.

According to some embodiments of the present disclosure, further comprising: a battery mounting portion disposed on the container body, wherein the battery mounting portion is adapted to mount a standard 18650-type battery; and the battery mounting portion is an external structure and is electrically connected to the main control board.

According to some embodiments of the present disclosure, the control circuit comprises: a control chip disposed on the main control board; an infrared transmitting and receiving unit electrically connected to the control chip, wherein the infrared transmitting and receiving unit is configured to send a detected hand-sweeping motion signal of a user to an input terminal of the control chip; a touch button unit electrically connected to the control chip, wherein the touch button unit is configured to send a detected power-on signal, a power-off signal, a lid opening signal, a lid closing signal, and a vacuum start signal to the input terminal of the control chip; a vacuum driving unit electrically connected to the control chip, wherein the vacuum driving unit is controlled by a vacuum starting signal output from an output terminal of the control chip to drive a motor of the vacuum pump to operate to control the vacuum-assisted bag deployment device inside the container body to execute a vacuum bag deployment operation; a motor driving unit electrically connected to the output terminal of the control chip, wherein the motor driving unit is controlled by a voltage detection result of a preset pin of the control chip to drive a motor of the lid drive mechanism to rotate forward or in reverse to execute a lid opening operation or a lid closing operation; and a power source electrically connected to the control chip, the infrared transmitting and receiving unit, the touch button unit, the vacuum driving unit, and the motor driving unit.

According to some embodiments of the present disclosure, the control circuit further comprises: a low voltage detection unit comprising a first resistor and a second resistor, wherein an input terminal of the low voltage detection unit is connected to the power source, and an output terminal of the low voltage detection unit is connected to the control chip, wherein the control chip issues a low power prompt and disables an infrared sensing signal of the infrared transmitting and receiving unit and a touch button operation signal of the touch button unit when detecting that a voltage output from the output terminal of the low voltage detection unit is lower than a first preset voltage; and wherein the control chip controls the waste container to execute a shutdown action when detecting that the voltage output from the output terminal of the low voltage detection unit is lower than a second preset voltage.

According to some embodiments of the present disclosure, the control circuit further comprises: a power indicator light unit, wherein an input terminal of the power indicator light unit is connected to an output terminal of the control chip, and the power indicator light unit comprises a third resistor and a first LED light, wherein the first LED light is configured to receive a first light control signal sent by the control chip, and the first light control signal indicates that the first LED light is steadily on for a first preset duration when the waste container is powered on, blinks for a second preset duration when the waste container is powered off, or blinks slowly when the waste container is in a low voltage state, wherein the low voltage state is a state in which a voltage output from the output terminal of the low voltage detection unit is higher than the second preset voltage and lower than the first preset voltage.

According to some embodiments of the present disclosure, the control circuit further comprises: an ambient light unit, wherein an input terminal of the ambient light unit is connected to an output terminal of the control chip, the ambient light unit comprises a fourth resistor and a second LED light, and the second LED light receives a second light control signal sent by the control chip, wherein the second light control signal indicates that the second LED light is lit when the motor of the lid drive mechanism rotates forward, or is extinguished when the motor of the lid drive mechanism rotates reversely.

According to some embodiments of the present disclosure, the control circuit further comprises: a USB charging management unit comprising a 6-pin Type-C connector and a charging management chip, wherein the USB charging management unit is electrically connected to the power source, and the USB charging management unit is configured to provide charging management for a built-in battery.

According to some embodiments of the present disclosure, wherein the infrared transmitting and receiving unit is disposed in a sensor mounting area of the waste container, and in a power-on state, the control chip controls the motor of the lid drive mechanism to rotate forward to automatically open the lid when the infrared transmitting and receiving unit senses a hand-sweeping motion signal of a user, and the control chip controls the motor of the lid drive mechanism to stop rotating when the control chip detects that a voltage of the preset pin is higher than a preset threshold; otherwise, if the control chip does not detect that the voltage of the preset pin is higher than the preset threshold, the control chip controls the motor of the lid drive mechanism to stop rotating after a third preset duration, and controls the motor of the lid drive mechanism to rotate reversely after a delay of a fourth preset duration to close the lid.

According to some embodiments of the present disclosure, the preset threshold is 0.2 V.

According to some embodiments of the present disclosure, wherein the control chip comprises a timing unit, and the timing unit performs timing when the motor driving unit drives the motor of the lid drive mechanism to rotate forward or to rotate reversely, and the control chip controls the motor driving unit to stop the motor when a running time reaches a preset time threshold and the control chip does not detect that a voltage of the preset pin is higher than the preset threshold.

According to some embodiments of the present disclosure, wherein the control chip controls the motor of the vacuum pump to run continuously for a fifth preset duration and then stop when the touch button unit receives a vacuum start signal.

Embodiments of the present disclosure provide a waste container and a control circuit thereof, which exhibit at least one of the following advantages or beneficial effects.

By adopting a lid having a frameless full-cover plate structure and rotatably connecting the lid to a top end of the container body, the lid completely covers a top opening of the container body when closed. This approach eliminates a raised border frame provided on conventional sensor-activated waste containers to avoid interference with a top sensing port, and the flat design without the raised border frame significantly improves the overall aesthetic appearance of the waste container, achieving a structural innovation of a borderless appearance.

An integrated sensor-activated lid opening structure is formed through electrical linkage between the sensor assembly and the lid drive mechanism. The sensor assembly is directly disposed at the front side of the container body, overcoming the structural limitation of conventional sensing ports disposed on the lid, providing a structural basis for realizing the frameless lid.

The sensor assembly is electrically connected to the main control board, and the lid drive mechanism is electrically connected to the sensor assembly, such that a sensing signal directly triggers the main control board to control the lid drive mechanism to drive the lid to flip and open.

At the same time, the sensor assembly is separated from the lid, which not only ensures the transmission stability of the sensing signal, but also avoids the problem of the lid structure interfering with the sensing effect in conventional products, thereby reducing false triggering and improving the accuracy of sensor-activated lid opening.

Further, additional aspects and advantages of the present disclosure will be set forth in part in the following description, and in part will be apparent from the following description, or may be learned by practice of the present disclosure.

### DESCRIPTION OF DRAWINGS

FIG. 1 is a first structural schematic diagram of a waste container according to an embodiment of the present disclosure.

FIG. 2 is a second structural schematic diagram of the waste container according to the embodiment of the present disclosure.

FIG. 3 shows a cross-sectional view of the waste container according to the embodiment of the present disclosure.

FIGS. 4a to 4c are structural schematic diagrams from a control circuit according to the embodiment of the present disclosure.

Indication of the reference numerals in the drawings are as follows:
100 container body;
200 lid;
300 sensor assembly;
400 lid drive mechanism; 410 first hinge; 420 second hinge;
500 main control board;
610 vacuum pump; 620 air suction holes;
710 first touch button; 720 second touch button;
800 indicator light; and
900 battery mounting portion.

### DETAILED DESCRIPTION

The following will provide a clear and complete description of the concept, specific structure, and technical effects of the disclosure, with the help of embodiments and accompanying drawings, in order to fully understand the purpose, solution, and effects of the disclosure. It should be noted that, unless conflicting, the features in the embodiments of this application can be combined with each other.

Furthermore, unless otherwise specified, when a feature is referred to as “fixed” or “connected” to another feature, it can be directly or indirectly fixed or connected to the other feature. Additionally, the terms “upper,” “lower,” “left,” “right,” “top,” “bottom,” and similar descriptions used in this disclosure are relative to the positional relationship between the components of the disclosure as depicted in the drawings.

Moreover, unless otherwise defined, all technical and scientific terms used in this document have the same meaning as commonly understood by those skilled in the art. The terms used in this document are only for describing specific embodiments and should not be construed as limiting the disclosure. The term “and/or” used herein includes any combination of one or more of the listed items.

It should be understood that, although the terms “first,” “second,” “third,” etc., may be used to describe various components in this disclosure, these components should not be limited to these terms. These terms are used to distinguish components of the same type from each other. For example, without departing from the scope of this disclosure, the first component may also be referred to as the second component, and similarly, the second component may also be referred to as the first component.

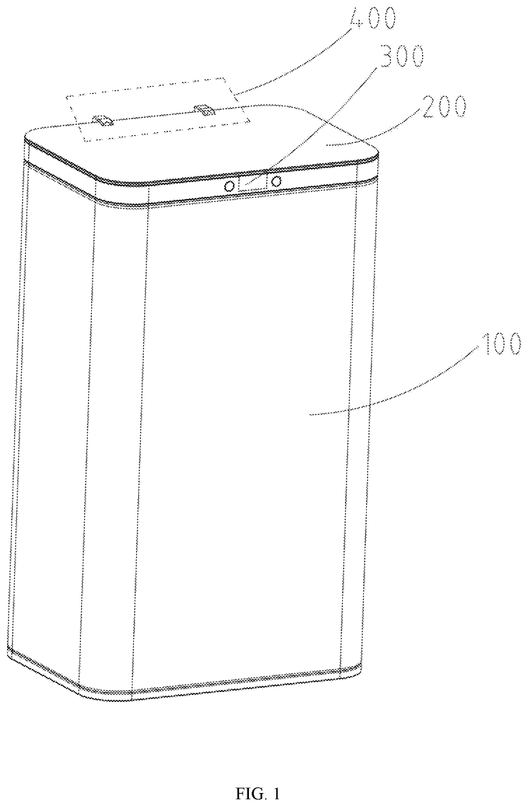

With reference to FIGS. 1 to 4c, the waste container and a control circuit thereof according to embodiments of the present disclosure will be further described below.

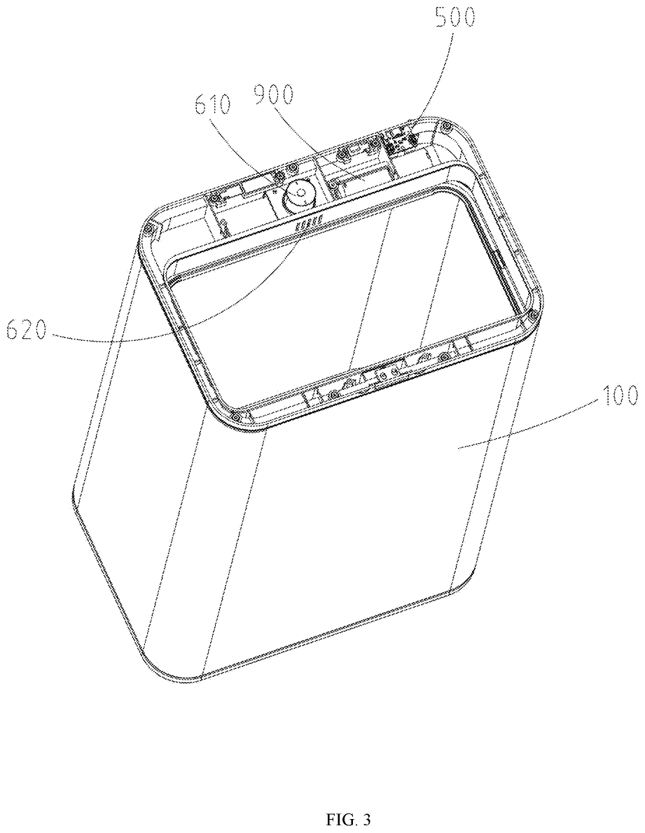

With reference to FIGS. 1 and 3, the waste container according to an embodiment of the present disclosure comprises: a container body 100, a lid 200 having a frameless full-cover plate structure and a pivot connected to one side of a top opening of the container body, a lid drive mechanism 400 connected to the container body 100, a main control board 500 disposed in the lid 200, and a sensor assembly 300 disposed directly in front of a top end of the container body 100, wherein the sensor assembly 300 is electrically connected to the main control board 500 and the lid drive mechanism 400, and wherein the main control board 500 is triggered by a sensing signal from the sensor assembly 300 to control the lid drive mechanism 400 to drive the lid 200 to flip and open, thereby achieving integrated sensor-activated lid opening of the waste container.

By adopting the lid 200 having a frameless full-cover plate structure and rotatably connecting the lid 200 to a top end of the container body 100, the lid 200 completely covers an opening of the container body 100 when in a closed state. This approach eliminates a raised border frame provided on conventional sensor-activated waste containers to avoid interference with a top sensing port, and the flat design without the raised border frame significantly improves the overall aesthetic appearance of the waste container, while also preventing dust accumulation and dirt concealment at a border of the lid 200, making cleaning and maintenance more convenient.

An integrated sensor-activated lid opening structure is formed through electrical linkage between the sensor assembly and the lid drive mechanism. By disposing the sensor assembly 300 directly in front of a top portion of the container body 100, the design overcomes the structural limitation of conventional sensing components disposed on the lid, providing a structural basis for realizing the frameless lid 200. The sensor assembly 300 is electrically connected to the main control board 500, and the lid drive mechanism 400 of the lid 200 is electrically connected to the sensor assembly 300, such that a sensing signal directly triggers the main control board 500 to control the lid drive mechanism 400 to drive the lid 200 to flip and open, achieving direct conversion from the sensing signal to a lid opening action. Moreover, the sensor assembly 300 of the present disclosure is independently disposed directly in front of the container body 100 and has no structural association with the lid 200, thereby avoiding occlusion or interference to the sensor assembly 300 caused by opening and closing of the lid 200, solving the problem of the lid structure interfering with the sensing effect in conventional waste container products, further improving the accuracy of sensor-activated lid opening of the waste container, and effectively reducing false triggering.

In some embodiments of the present disclosure, the sensor assembly 300 is mounted in a sensor mounting area provided on a front outer wall of a top end of the container body 100, the sensor assembly 300 is fixedly mounted in the sensor mounting area, the sensor assembly 300 comprises a sensor head, the sensor head is disposed in the sensor mounting area at an upward inclination angle of 45 degrees, and the sensor head has an oblique sensing direction outward from a front side of the container body 100.

By disposing the sensor head in the sensor mounting area at a 45-degree upward inclination, with its sensing direction directed obliquely upward toward the front side of the container body 100, this structural design achieves a dual adaptation between sensing accuracy and user operating habits. The 45-degree inclination angle conforms to users' conventional hand sweeping habits for opening the lid, significantly improving operational adaptability and user experience. Meanwhile, it effectively avoids false triggering of sensing signals caused by people passing by or objects moving in the front, and also prevents interference with sensing signals from dust particles, mosquitoes, and other debris above the container body 100, thereby fundamentally solving the drawback of conventional sensor-activated waste containers frequently opening and closing automatically at night due to interference signals from dust particles, mosquitoes, flies, and the like in the air during infrared sensing.

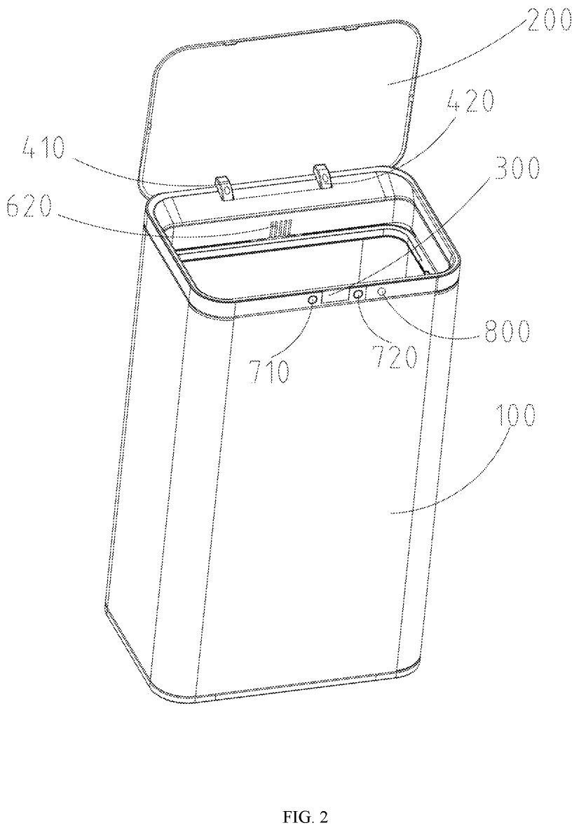

In some embodiments of the present disclosure, With reference to FIGS. 2 and 3, the waste container further comprises a vacuum-assisted bag deployment device, comprising a vacuum pump 610 and a plurality of air suction holes 620, wherein the vacuum pump 610 is disposed inside the container body 100, and the air suction holes 620 are evenly distributed on an inner side wall of the container body 100.

It can be understood that an area within the can wall between a trash bag and the plurality of air suction holes 620 forms an air guide channel, the air suction holes 620 are in communication with the air guide channel, and the air guide channel is in communication with a suction end of the vacuum pump 610.

Embodiments of the present disclosure additionally provide a vacuum-assisted bag deployment device comprising the vacuum pump 610, the air guide channel, and the air suction holes 620, forming a coherent air extraction structural system to achieve automated fitting and deployment of a trash bag.

When the vacuum pump 610 operates, air between an inner side wall of the container body 100 and the trash bag is rapidly extracted through the air suction holes 620 via the air guide channel, and by utilizing atmospheric pressure, the trash bag is caused to closely fit against an inner wall of the container body 100, thereby completely replacing a conventional manual pressing bag deployment manner, freeing the user's hands, significantly improving the convenience of bag deployment operations, and also avoiding problems of poor fitting and slipping of the trash bag resulting from uneven manual pressing force. The evenly distributed air suction holes 620 allow the suction force to be uniformly applied across the inner wall of the container body 100, enabling the trash bag to fit against the can wall more comprehensively and tightly, effectively preventing displacement and detachment of the trash bag during trash disposal, and ensuring cleanliness during use.

In some embodiments of the present disclosure, a protective baffle is provided on an inner side of the air suction holes 620 to prevent the trash bag from blocking the holes.

The protective baffle is a thin plate body having a hollow grid structure, is annularly attached and fixed to an inner side of the air suction holes 620 on an inner side wall of the container body 100, grid through-holes on the protective baffle correspond to the air suction holes 620 in a one-to-one manner and have a smaller diameter than the air suction holes 620, a tiny gap is left between the protective baffle and the inner side wall of the container body 100, and the protective baffle is integrally formed as an injection-molded structure adapted to the container body 100.

The protective baffle can effectively prevent the trash bag from directly adhering to the air suction holes 620 and causing blockage of the holes, ensuring smooth air circulation during suction and guaranteeing the air extraction efficiency of the vacuum-assisted bag deployment device. The hollow grid design does not affect the air extraction effect, and can also prevent trash debris from entering the air suction holes 620 and causing clogging, thereby reducing equipment failures and extending the service life of the vacuum-assisted bag deployment device.

In some embodiments of the present disclosure, a first touch button 710 and a second touch button 720 are provided in the sensor mounting area, both the first touch button 710 and the second touch button 720 are electrically connected to the main control board 500, the first touch button 710 is configured to control a working state of the vacuum pump 610, and the second touch button 720 is configured to control a power on/off state of the waste container and control an open/closed state of the lid 200.

In one embodiment, the first touch button 710 is disposed on the left side of the sensor head, and serves as a vacuum function trigger button. A long press on the first touch button 710 for two seconds triggers a vacuum action. It can be understood that, with the first touch button 710 being positioned adjacent to the sensor mounting area, the long-press triggering manner effectively avoids inadvertent activation of the vacuum pump 610 due to inadvertent touches, thereby ensuring operational stability.

In some embodiments of the present disclosure, the main control board 500 controls the waste container to be in a power-on state in response to the second touch button 720 operating in a first activation mode;
the main control board 500 controls the waste container to be in a power-off state the second touch button 720 operating in a second activation mode;
the main control board 500 controls the lid 200 to flip and open and remain in an open state in response to the second touch button 720 operating in a third activation mode; and
the main control board 500 controls the lid 200 to be in a closed state in response to the second touch button 720 operating in a fourth activation mode.

In one embodiment, the second touch button 720 is disposed on the right side of the sensor head, and serves as a power on/off and lid opening control button for the waste container. When the second touch button 720 operates in a first activation mode, for example, a long press on the second touch button 720 for three seconds can achieve power-on of the waste container; when the second touch button 720 operates in a second activation mode, for example, when the waste container is in a power-on state, long-pressing the second touch button 720 again for three seconds can achieve power-off of the waste container. When the second touch button 720 operates in a third activation mode, for example, a brief touch on the second touch button 720 once can control the lid 200 to flip and open at 90 degrees and remain in the open state; and when the second touch button 720 operates in a fourth activation mode, for example, when the lid 200 is in a 90-degree flipped open state and remains open, lightly touching the second touch button 720 again can control the lid 200 to close.

It can be seen that the second touch button 720 achieves control of the power on/off of the waste container, the opening and closing of the lid 200, and maintaining the lid 200 in an open state through four different activation modes respectively.

This multi-mode touch control design allows a single button to realize multi-function integrated control. Different activation modes correspond to different function instructions; the functions are clearly divided, the operation logic is simple, and no redundant buttons need to be added.

In some embodiments of the present disclosure, the waste container further comprises an indicator light 800 disposed on an outer side of the sensor mounting area, wherein the indicator light 800 is electrically connected to the main control board 500 and is configured to indicate a power on/off working state of the waste container.

By disposing the indicator light 800, which is electrically connected to the main control board 500, on the outer side of the sensor mounting area, the indicator light 800 is dedicated to displaying the power on/off state. By observing the indicator light 800, users can intuitively and quickly check the operating state of the waste container; the indicator light 800 is electrically connected to the main control board 500, providing an intuitive indication of lighting upon power-on and extinguishing upon power-off, effectively avoiding misoperation, while also visualizing the working state of the waste container, facilitating the user to promptly detect equipment abnormalities.

In some embodiments of the present disclosure, the lid drive mechanism 400 comprises, but is not limited to, a hinge assembly disposed on one side of a top end of the container body 100. The lid 200 is rotatably connected to the container body 100 through the hinge assembly. A torsion spring is further disposed in the hinge assembly, and two ends of the torsion spring respectively abut against the container body 100 and the lid 200. A drive member is further disposed in the container body 100, and the drive member is electrically connected to the main control board 500, and an output end of the drive member is drivingly connected to the lid 200 to drive the lid 200 to flip.

In the lid drive mechanism 400, with reference to FIG. 2, the hinge assembly comprises a first hinge 410 and a second hinge 420. The first hinge 410 and the second hinge 420 provide stable rotational support for the lid 200, ensuring smoothness during the flipping process of the lid 200. In cooperation with the elastic force of the torsion spring, the lid is assisted to reset, so that the closing action of the lid 200 is more tightly fitted and free from looseness. The drive member is electrically connected to the main control board 500, and is precisely controlled by sensing signals or button commands to achieve automated flipping of the lid 200.

In some embodiments of the present disclosure, the drive member is a micro motor, an output shaft of the micro motor is drivingly connected to the hinge assembly through a gear set, and a rotation angle of the micro motor is precisely controlled by the main control board 500 to enable an opening angle of the lid 200 to be 90 degrees.

With the micro motor serving as the drive member, power is transmitted to the hinge assembly via the gear set, and the main control board 500 precisely controls the rotation angle to achieve a 90-degree opening of the lid 200. The gear set transmission enables more stable and precise power transfer, avoiding sticking of the lid 200 during opening and closing. The main control board 500 precisely controls the rotation angle of the motor to enable the lid 200 to stably maintain the 90-degree open state, satisfying the user's need for extended trash disposal.

In some embodiments of the present disclosure, a battery mounting portion 900 is disposed on the container body 100, wherein the battery mounting portion 900 is adapted to mount a standard 18650-type battery; and the battery mounting portion 900 is an external structure and is electrically connected to the main control board 500.

Unlike conventional sensor-activated waste container lids that mostly employ built-in batteries, the external battery mounting portion design of the embodiment of the present disclosure enables battery replacement and charging without disassembling the container body 100, making operation convenient. The battery mounting portion is adapted to universal 18650-type batteries, which are readily available for users to purchase and replace without requiring dedicated accessories. The 18650 battery directly supplies power to the low-power-consumption main control board 500, ensuring efficient power transmission and stable operation of the waste container and significantly improving the convenience of use and battery life adaptability of the waste container.

In some embodiments of the present disclosure, the battery mounting portion 900 is provided with a reverse polarity protection structure. The reverse polarity protection structure includes contacts. When a battery is inserted with incorrect polarity, the positive and negative terminals thereof cannot contact the contacts in the battery mounting portion 900, thereby preventing damage to the main control board 500 caused by a user inadvertently installing the battery in reverse, and improving the reliability and safety of the product.

In one embodiment, the main control board 500 has a power consumption of approximately 0.3 mA. In contrast, an average power consumption of the main control board 500 used in conventional sensor-activated lids on the market is 0.94 mA. Thus, the main control board 500 provided by the present disclosure has a battery life that is three times longer than that of the main control boards used in conventional sensor-activated lids. Therefore, while a conventional sensor-activated waste container using an 18650-type battery has a service life of only about one month, the main control board 500 used in the lid 200 provided by the present disclosure can operate for more than three months, greatly improving the battery life and service life of the waste container.

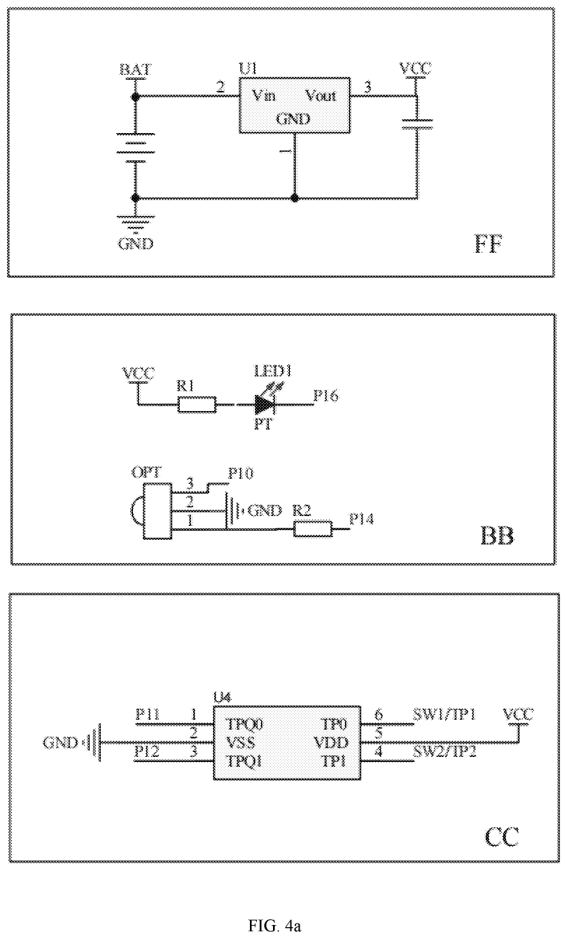

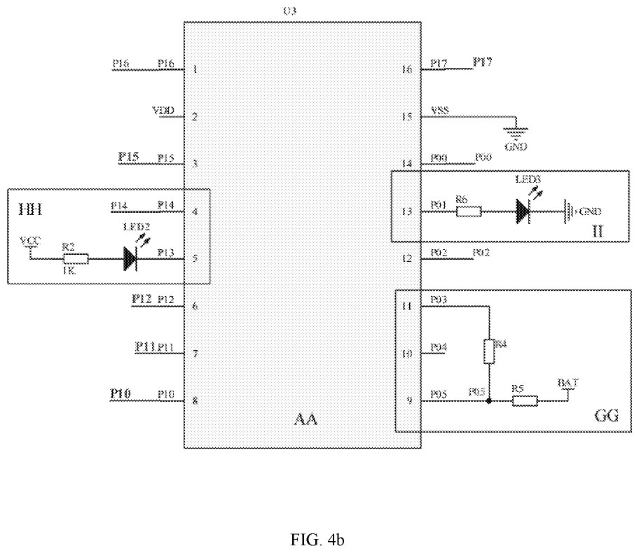

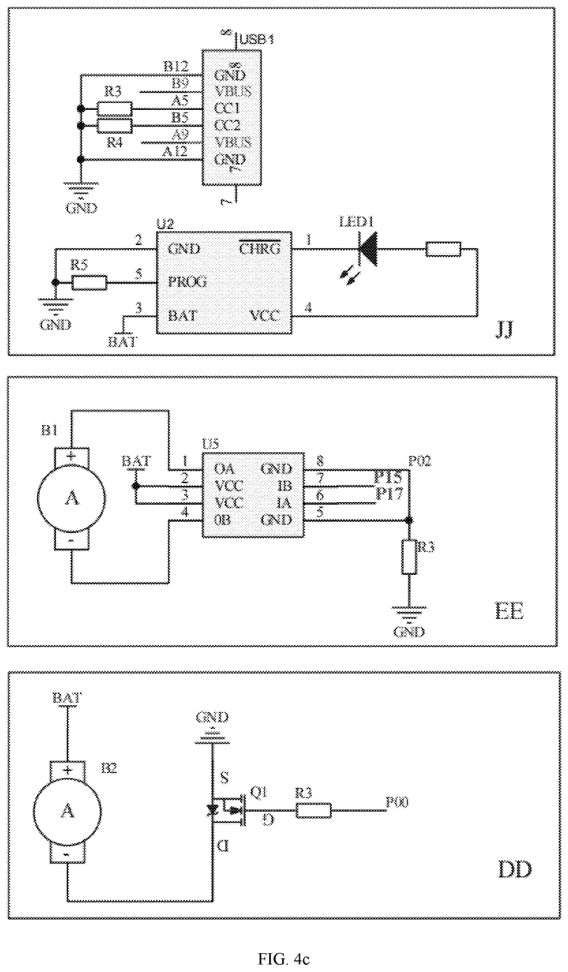

In some embodiments of the present disclosure, the waste container further includes a control circuit. With reference to FIGS. 4a to 4c, the control circuit includes: a control chip AA disposed on the main control board; an infrared transmitting and receiving unit BB electrically connected to an input terminal of the control chip; a touch button unit CC electrically connected to an input terminal of the control chip; a vacuum driving unit DD electrically connected to an output terminal of the control chip; a motor driving unit EE electrically connected to an output terminal of the control chip; and a power source FF electrically connected to the control chip AA, the infrared transmitting and receiving unit BB, the touch button unit CC, the vacuum driving unit DD, and the motor driving unit EE.

It is to be understood that, in the control circuit, the infrared transmitting and receiving unit BB sends a detected hand-sweeping motion signal of a user to an input terminal of the control chip AA; the touch button unit CC sends a detected power-on signal, power-off signal, lid opening signal, lid closing signal, and vacuum starting signal to an input terminal of the control chip AA; the vacuum driving unit DD is controlled by a vacuum start signal output from an output terminal of the control chip AA to drive a motor of the vacuum pump to operate to control the vacuum-assisted bag deployment device in the container body to execute a vacuum bag deployment operation; and the motor driving unit EE is controlled by a voltage detection result of a preset pin of the control chip to drive a motor of the lid drive mechanism to rotate forward or in reverse to execute a lid opening operation or a lid closing operation. Throughout the entire working process of the control circuit, the power source FF provides a working voltage to the control chip AA, the infrared transmitting and receiving unit BB, the touch button unit CC, the vacuum driving unit DD, and the motor driving unit EE.

It can be seen that the control circuit integrates the power source FF, the control chip AA, the infrared transmitting and receiving unit BB, the touch button unit CC, the motor driving unit EE, and the vacuum driving unit DD in a circuit architecture, forming a complete closed-loop control system. The infrared transmitting and receiving unit BB achieves contactless hand-sweeping sensing, and a user only needs to lightly sweep the sensor mounting area corresponding to the infrared transmitting and receiving unit BB to automatically complete lid opening and closing operations, avoiding direct contact. The touch button unit CC is equipped with a second touch button supporting a long-press power on/off function and a short-press lid opening and closing function, and a first touch button supporting a vacuum starting function, thereby achieving multi-mode, multi-function human-machine interaction with clear operation logic and improving user experience.

In terms of motor and vacuum control, the control circuit precisely controls forward and reverse rotation of the motor of the lid drive mechanism through the motor driving unit EE. The control chip AA controls the motor driving unit EE and the vacuum driving unit DD to execute corresponding operations based on a voltage detection result of a preset pin, effectively preventing motor jamming or overloading, and ensuring reliability and safety of the lid opening and closing actions of the lid.

In terms of power consumption control, the control chip AA employs a low-power microcontroller, low-power ICs, and a low-power circuit design, enabling standby power consumption of the entire waste container to be lower than 0.05 mA, thereby significantly reducing static power consumption, extending battery life in battery-powered scenarios, satisfying green energy-saving application requirements, and ensuring stable operation of the control circuit.

In some embodiments of the present disclosure, the control circuit further comprises a low voltage detection unit GG. The low voltage detection unit GG includes a first resistor R4 and a second resistor R5. An input terminal of the low voltage detection unit GG is connected to the power source FF, and an output terminal of the low voltage detection unit GG is connected to the control chip AA, wherein the control chip AA issues a low power prompt and disables an infrared sensing signal of the infrared transmitting and receiving unit BB and a touch button operation signal of the touch button unit CC when detecting that a voltage output from the output terminal of the low voltage detection unit GG is lower than a first preset voltage. And the control chip AA controls the waste container to execute a shutdown action when detecting that the voltage output from the output terminal of the low voltage detection unit GG is lower than a second preset voltage.

The low voltage detection unit GG employs a simple resistor voltage divider network and a hierarchical threshold control strategy. In terms of circuit implementation, the low voltage detection unit GG is composed of a first resistor R4 and a second resistor R5, featuring a simple structure and requiring no complex active components or dedicated detection chips, thereby effectively reducing the complexity of the control circuit and material costs. The voltage divided by the resistors is directly input to an analog-to-digital conversion port of the control chip AA, thereby achieving real-time, continuous monitoring of a voltage state of the power source FF.

In terms of functional control, a dual-threshold hierarchical response mechanism is adopted to achieve precise response to a voltage state of the power source FF. When the control chip AA detects that the output voltage of the low voltage detection unit GG is lower than the first preset voltage (for example, the first preset voltage is 1.7 V), the control chip AA issues a low power prompt to remind the user to charge or replace the battery in a timely manner, and simultaneously disables the infrared sensing signal and the touch button operation signal. This design prevents motor jamming, drive failure, or system abnormalities caused by misoperation under insufficient voltage conditions, thereby protecting the motor and drive circuits. When the voltage further drops below the second preset voltage (for example, the second preset voltage is 1.4 V), the control chip AA automatically executes a shutdown action to cut off main functional loads, preventing irreversible damage to battery life and control circuit stability caused by over-discharge of the power source FF.

Furthermore, the low voltage detection mechanism creates a synergistic effect with the low-power consumption design of the entire waste container. In a standby state, the low voltage detection unit GG itself consumes almost no additional power, while the hierarchical response strategy can orderly shutdown non-core functions before the power source FF is depleted, avoiding repeated attempts to start the motor and other high-power-consumption operations under low voltage conditions, thereby extending effective usage time and ensuring that critical data and states are stably maintained.

In some embodiments of the present disclosure, the control circuit further comprises a power indicator light unit HH. wherein an input terminal of the power indicator light unit HH is connected to an output terminal of the control chip AA, and the power indicator light unit HH comprises a third resistor and a first LED light, wherein the first LED light is configured to receive a first light control signal sent by the control chip AA, and the first light control signal indicates that the first LED light is steadily on for a first preset duration when the waste container is powered on, blinks for a second preset duration when the waste container is powered off, or blinks slowly when the waste container is in a low voltage state, wherein the low voltage state is a state in which a voltage output from the output terminal of the low voltage detection unit GG is higher than the second preset voltage and lower than the first preset voltage.

The power indicator light unit HH achieves a three-level differentiated display for status indication. After the waste container is powered on, the first LED light LED2 remains steadily on for a first preset duration (for example, 2 seconds), informing the user that the waste container has been successfully started and is ready for normal use. During the power-off process of the waste container, the first LED light LED2 blinks for a second preset duration (for example, 2 seconds), providing visual feedback confirming that the shutdown instruction has been executed. When entering a low voltage state, that is, when the voltage of the power source FF is higher than the second preset voltage (for example, 1.4 V) but lower than the first preset voltage (for example, 1.7 V), the first LED light LED2 adopts a slow blinking mode for prompting, facilitating the user to intuitively perceive feedback on the usage state of the waste container. After the control circuit is powered on, a long press on the first touch button SW1/TP1 until LED1 lights up indicates power-on of the waste container, and another long press until LED1 blinks three times and then extinguishes indicates power-off of the waste container.

It can be understood that, in the low voltage state, since the control chip AA has already disabled the infrared sensing signal and the touch button operation signal, the appearance of a slow blinking light can promptly inform the user that the waste container has insufficient power and requires charging, thereby avoiding misjudgment or confusion caused by unresponsive operations. This design effectively connects the power source FF management strategy with human-machine interaction feedback.

In some embodiments of the present disclosure, the control circuit further comprises an ambient light unit II. An input terminal of the ambient light unit II is connected to an output terminal of the control chip AA. The ambient light unit II includes a fourth resistor and a second LED light. The second LED light receives a second light control signal sent by the control chip AA. The second light control signal indicates that the second LED light is lit when the motor of the lid drive mechanism rotates forward, or is extinguished when the motor of the lid drive mechanism rotates reversely.

It can be understood that, the ambient light unit II is composed of a fourth resistor R6 and a second LED light LED3, with a simplified structure. An input terminal of the ambient light unit II is connected to an output terminal of the control chip AA. The control chip AA sends the second light control signal in real time according to a motor driving state, achieving precise synchronization between the light and the lid opening action. When the motor of the lid drive mechanism rotates forward to execute a lid opening action, the second LED light LED3 lights up instantly, providing visual light feedback to the user to indicate that the lid is being opened. When the motor rotates reversely to execute a lid closing action, the second LED light LED3 is extinguished accordingly.

This synchronization mechanism of light on during lid opening and light extinguishing during lid closing enables the user to clearly confirm an open/closed state of the lid in an environment with insufficient light, effectively improving visibility and convenience of operation.

In some embodiments of the present disclosure, the control circuit further comprises a USB charging management unit, wherein the USB charging management unit comprises a 6-pin Type-C connector and a charging management chip, the USB charging management unit is electrically connected to the power source FF, and is configured to provide charging management for a built-in battery.

The USB charging management unit is composed of a 6-pin Type-C interface and a charging management chip. The USB charging management unit is directly electrically connected to the power source FF, forming a complete charge-discharge circuit to provide safe and convenient charging management functions for the built-in battery. The charging management chip of the USB charging management unit is provided with multiple safety mechanisms including constant current and constant voltage charging control, overcharge protection, over-discharge protection, and overheat protection, ensuring that the built-in battery is always in a safe operating condition during the charging process, and effectively extending the cycle life of the battery. When the control circuit is in a low voltage state, a user can charge the waste container through a standard Type-C interface, and the charging management chip automatically adjusts the charging current and voltage without manual intervention. During charging, in combination with the power indicator light unit HH providing real-time feedback on a charging state of the waste container, thereby enhancing the user interaction experience.

It should be noted that, in embodiments of the present disclosure, the control chip AA is a low-power-consumption main control board, and a model number of the low-power-consumption main control board is MC32P7311AOK. The standby power consumption of the low-power-consumption main control board is lower than 0.05 mA, which can significantly extend battery life. However, the standby power consumption of most sensor-activated waste container lids available on the market is 0.3 mA, 0.6 mA, or 0.9 mA. Therefore, the present disclosure exhibits outstanding advancement in standby power consumption configuration compared with ordinary waste container products available on the market.

In some embodiments of the present disclosure, in the control circuit, the infrared transmitting and receiving unit BB is disposed in a sensor mounting area of the waste container, and in a power-on state, the control chip AA controls the motor of the lid drive mechanism to rotate forward to automatically open the lid when the infrared transmitting and receiving unit BB continuously detects a hand-sweeping motion of a user, and the control chip AA controls the motor of the lid drive mechanism to stop rotating. when the control chip AA detects that a voltage at a preset pin is higher than a preset threshold; otherwise, if the control chip AA does not detect that the voltage at the preset pin is higher than the preset threshold, the control chip AA controls the motor of the lid drive mechanism to stop rotating after a third preset duration, and to rotate reversely after a delay of a fourth preset duration so as to close the lid.

The control chip AA determines whether the lid is fully opened by monitoring in real time a voltage state of a preset pin (for example, a P02 pin). When a voltage at the P02 pin is detected to be higher than a preset threshold, it indicates that the lid has been fully opened, and the control chip AA immediately stops rotation of the motor B1 of the lid drive mechanism, thereby avoiding mechanical jamming or motor stalling caused by over-travel. If the voltage at the P02 pin is not detected to exceed the preset threshold during the opening process, the motor B1 of the lid drive mechanism is automatically stopped after a third preset duration (for example, 2 seconds), so as to prevent the motor from idling for an extended period or overloading due to sensor failure or mechanical malfunction, and effectively protect the motor B1 of the lid drive mechanism and the drive circuit.

After the lid opening action stops rotating and a fourth preset duration elapses (for example, 4 seconds), the motor B1 of the lid drive mechanism is automatically driven to rotate in reverse to execute a lid closing action, thereby achieving automatic reset without human intervention. If the voltage at the P02 pin is not detected to exceed the preset threshold during the closing process either, the motor B1 of the lid drive mechanism is also stopped rotating after a second preset duration, thereby ensuring operational safety. This complete closed-loop control strategy enables the waste container to safely and reliably complete opening and closing actions under both normal and abnormal operating conditions. The synergistic control mechanism between the infrared transmitting and receiving unit BB and the motor driving unit EE achieves intelligent and reliable contactless automatic lid opening and closing functions for the waste container with an integrated sensor-activated lid opening function.

In some embodiments of the present disclosure, the preset threshold is 0.2 V, so as to achieve precise in-position detection. This low threshold design enables the control circuit to be highly sensitive to position changes of the lid, allowing timely response and motor stopping when the lid reaches the fully opened or fully closed position, effectively preventing mechanical jamming or motor stalling caused by over-travel. Meanwhile, this threshold cooperates with a timeout protection mechanism to form a dual safeguard of software and hardware, ensuring action reliability while significantly improving the safety and service life of the motor drive system.

In one embodiment of the present disclosure, when the waste container is in a power-on state, upon a short touch on the first touch button SW1/TP1, the motor B1 of the lid drive mechanism rotates forward. The motor B1 of the lid drive mechanism stops rotating when a voltage at the P02 pin of the control chip AA is detected to be higher than 0.2 V. If the voltage at the P02 pin of the control chip AA is not detected to be higher than 0.2 V, the motor B1 of the lid drive mechanism stops rotating after 2 seconds. Subsequently, when the user touches the first touch button SW1/TP1 again, the control chip AA controls the lid to execute a lid closing action.

In some embodiments of the present disclosure, the control chip AA comprises a timing unit, and the timing unit is configured to perform timing when the motor driving unit EE drives the motor B1 of the lid drive mechanism to rotate forward or in reverse, and the control chip controls the motor driving unit to stop the motor when a running time reaches a preset time threshold and the control chip AA does not detect that a voltage of the preset pin is higher than the preset threshold

The timing unit integrated in the control chip AA provides a critical timeout protection mechanism for driving the motor B1 of the lid drive mechanism. The timing unit records the running time in real time when the motor B1 of the lid drive mechanism rotates forward or in reverse. And the control chip AA immediately stops operation of the lid drive mechanism if the running time reaches a preset threshold and the voltage at the P02 pin is still not higher than the preset threshold (i.e., no in-position signal is detected). This mechanism effectively prevents the motor from idling for an extended period or stalling due to sensor failure, mechanical jamming, or abnormal in-position signals, thereby avoiding overload damage to the motor B1 of the lid drive mechanism and wasted energy consumption, and achieving redundant protection through software-hardware synergy.

In some embodiments of the present disclosure, the control chip AA controls the motor B2 of the vacuum pump to rotate and execute a vacuum bag deployment operation, and controls the motor B2 of the vacuum pump to run continuously for a fifth preset duration and then stop in response to the touch button unit CC receives a vacuum start signal.

The vacuum-assisted bag deployment function is triggered by a single touch on the second touch button SW2/TP2, achieving convenient and intelligent automated operation. In a power-on state, when the user gives a short touch on the second touch button SW2/TP2, the control chip AA immediately drives the motor B2 of the vacuum pump to rotate and execute a vacuum bag deployment operation, without requiring continuous pressing or additional intervention. The motor B2 of the vacuum pump automatically stops after running continuously for a fifth preset duration (for example, 15 seconds), ensuring that the vacuum bag deployment operation is fully completed, while also avoiding energy waste or motor overheating caused by prolonged operation. This design balances operational simplicity, functional reliability, and system safety, significantly improving user experience and the intelligence level of the entire waste container.

The above description is only a preferred embodiment of the disclosure. The disclosure is not limited to the above embodiments. As long as the same means can achieve the technical effects of the disclosure, any modifications, equivalent substitutions, improvements, etc., made within the spirit and principles disclosed herein should be included within the scope of the disclosure. Various modifications and variations can be made to the technical solution and/or implementation method within the scope of the disclosure.

1. A waste container, comprising:
a container body;
a lid having a frameless full-cover plate structure and a pivot connected to one side of a top opening of the container body;
a lid drive mechanism connected to the container body;
a main control board disposed in the lid; and
a sensor assembly disposed directly in front of a top end of the container body,
wherein the sensor assembly is electrically connected to the main control board and the lid drive mechanism, and wherein the main control board is triggered by a sensing signal from the sensor assembly to control the lid drive mechanism to drive the lid to flip and open.

2. The waste container according to claim 1, wherein the sensor assembly is mounted in a sensor mounting area provided on a front outer wall of a top end of the container body, the sensor assembly comprises a sensor head disposed in the sensor mounting area at an upward inclination angle of 45 degrees, and the sensor head has an oblique sensing direction outward from a front side of the container body.

3. The waste container according to claim 2, comprising:
a vacuum-assisted bag deployment device comprising a vacuum pump and a plurality of air suction holes, wherein the vacuum pump is disposed inside the container body, and the air suction holes are evenly distributed on an inner side wall of the container body.

4. The waste container according to claim 3, wherein a first touch button and a second touch button are provided in the sensor mounting area, both the first touch button and the second touch button are electrically connected to the main control board, the first touch button is configured to control a working state of the vacuum pump, and the second touch button is configured to control a power on/off state of the waste container and control an open/closed state of the lid.

5. The waste container according to claim 4, wherein:
the main control board controls the waste container to be in a power-on state in response to the second touch button operating in a first activation mode;
the main control board controls the waste container to be in a power-off state in response to the second touch button operating in a second activation mode;
the main control board controls the lid to flip and open and remain in an open state in response to the second touch button operating in a third activation mode; and
the main control board controls the lid to be in a closed state in response to the touch button operating in a fourth activation mode.

6. The waste container according to claim 2, comprising:
an indicator light disposed on an outer side of the sensor mounting area, wherein the indicator light is electrically connected to the main control board, and is configured to indicate a power on/off state of the waste container.

7. The waste container according to claim 1, wherein the lid drive mechanism comprises a hinge assembly disposed on one side of a top end of the container body, the lid is rotatably connected to the container body through the hinge assembly, a torsion spring is disposed in the hinge assembly, two ends of the torsion spring respectively abutting against the container body and the lid, a drive member is disposed in the container body and is electrically connected to the main control board, and an output end of the drive member is drivingly connected to the lid to drive the lid to flip.

8. The waste container according to claim 7, wherein the drive member is a micro motor, and an output shaft of the micro motor is drivingly connected to the hinge assembly through a gear set, and a rotation angle of the micro motor is controlled by the main control board to enable an opening angle of the lid to be 90 degrees.

9. The waste container according to claim 1, comprising:
a battery mounting portion disposed on the container body, wherein the battery mounting portion is adapted to mount a standard 18650-type battery; and the battery mounting portion is an external structure and is electrically connected to the main control board.

10. The waste container according to claim 1, comprising a control circuit, wherein the control circuit comprises:
a control chip disposed on the main control board;
an infrared transmitting and receiving unit electrically connected to the control chip, wherein the infrared transmitting and receiving unit is configured to send a detected hand-sweeping motion signal of a user to an input terminal of the control chip;
a touch button unit electrically connected to the control chip, wherein the touch button unit is configured to send a detected power-on signal, a power-off signal, a lid opening signal, a lid closing signal, and a vacuum start signal to the input terminal of the control chip;
a vacuum driving unit electrically connected to the control chip, wherein the vacuum driving unit is controlled by a vacuum starting signal output from an output terminal of the control chip to drive a motor of the vacuum pump to operate to control the vacuum-assisted bag deployment device inside the container body to execute a vacuum bag deployment operation;
a motor driving unit electrically connected to the output terminal of the control chip, wherein the motor driving unit is controlled by a voltage detection result of a preset pin of the control chip to drive a motor of the lid drive mechanism to rotate forward or in reverse to execute a lid opening operation or a lid closing operation; and
a power source electrically connected to the control chip, the infrared transmitting and receiving unit, the touch button unit, the vacuum driving unit, and the motor driving unit.

11. The waste container according to claim 10, wherein the control circuit comprises:
a low voltage detection unit comprising a first resistor and a second resistor, wherein an input terminal of the low voltage detection unit is connected to the power source, and an output terminal of the low voltage detection unit is connected to the control chip, wherein the control chip issues a low power prompt and disables an infrared sensing signal of the infrared transmitting and receiving unit and a touch button operation signal of the touch button unit when detecting that a voltage output from the output terminal of the low voltage detection unit is lower than a first preset voltage; and wherein the control chip controls the waste container to execute a shutdown action when detecting that the voltage output from the output terminal of the low voltage detection unit is lower than a second preset voltage.

12. The waste container according to claim 11, wherein the control circuit comprises:
a power indicator light unit, wherein an input terminal of the power indicator light unit is connected to an output terminal of the control chip, and the power indicator light unit comprises a third resistor and a first LED light, wherein the first LED light is configured to receive a first light control signal sent by the control chip, and the first light control signal indicates that the first LED light is steadily on for a first preset duration when the waste container is powered on, blinks for a second preset duration when the waste container is powered off, or blinks slowly when the waste container is in a low voltage state, wherein the low voltage state is a state in which a voltage output from the output terminal of the low voltage detection unit is higher than the second preset voltage and lower than the first preset voltage.

13. The waste container according to claim 11, wherein the control circuit comprises:
an ambient light unit, wherein an input terminal of the ambient light unit is connected to an output terminal of the control chip, the ambient light unit comprises a fourth resistor and a second LED light, and the second LED light receives a second light control signal sent by the control chip, wherein the second light control signal indicates that the second LED light is lit when the motor of the lid drive mechanism rotates forward, or is extinguished when the motor of the lid drive mechanism rotates reversely.

14. The waste container according to claim 10, wherein the control circuit comprises:
a USB charging management unit comprising a 6-pin Type-C connector and a charging management chip, wherein the USB charging management unit is electrically connected to the power source, and the USB charging management unit is configured to provide charging management for a built-in battery.

15. The waste container according to claim 10, wherein the infrared transmitting and receiving unit is disposed in a sensor mounting area of the waste container, and in a power-on state, the control chip controls the motor of the lid drive mechanism to rotate forward to automatically open the lid when the infrared transmitting and receiving unit senses a hand-sweeping motion signal of a user, and the control chip controls the motor of the lid drive mechanism to stop rotating when the control chip detects that a voltage of the preset pin is higher than a preset threshold; otherwise, if the control chip does not detect that the voltage of the preset pin is higher than the preset threshold, the control chip controls the motor of the lid drive mechanism to stop rotating after a third preset duration, and controls the motor of the lid drive mechanism to rotate reversely after a delay of a fourth preset duration to close the lid.

16. The waste container according to claim 15, wherein the preset threshold is 0.2 V.

17. The waste container according to claim 15, wherein the control chip comprises a timing unit, and the timing unit performs timing when the motor driving unit drives the motor of the lid drive mechanism to rotate forward or to rotate reversely, and the control chip controls the motor driving unit to stop the motor when a running time reaches a preset time threshold and the control chip does not detect that a voltage of the preset pin is higher than the preset threshold.

18. The waste container according to claim 12, wherein the control chip controls the motor of the vacuum pump to run continuously for a fifth preset duration and then stop when the touch button unit receives a vacuum start signal.

19. A control circuit for a waste container waste container having a sensor assembly disposed directly in front of a top end of the container body, comprising:
a control chip connected to the sensor assembly;
an infrared transmitting and receiving unit electrically connected to the control chip, wherein the infrared transmitting and receiving unit is configured to send a detected hand-sweeping motion signal of a user to an input terminal of the control chip;
a touch button unit electrically connected to the control chip, wherein the touch button unit is configured to send a detected power-on signal, a power-off signal, a lid opening signal, a lid closing signal, and a vacuum start signal to the input terminal of the control chip;
a vacuum driving unit electrically connected to the control chip, wherein the vacuum driving unit is controlled by a vacuum starting signal output from an output terminal of the control chip to drive a motor of the vacuum pump to operate to control the vacuum-assisted bag deployment device inside the container body to execute a vacuum bag deployment operation;
a motor driving unit electrically connected to the output terminal of the control chip, wherein the motor driving unit is controlled by a voltage detection result of a preset pin of the control chip to drive a motor of the lid drive mechanism to rotate forward or in reverse to execute a lid opening operation or a lid closing operation; and
a power source electrically connected to the control chip, the infrared transmitting and receiving unit, the touch button unit, the vacuum driving unit, and the motor driving unit.
